(19) United States
(12) Patent Application Publication
(10) Pub. No.: US 2014/0131512 A1
(43) Pub. Date: May 15, 2014

(54) SEAL AND ELECTRICAL CONDUCTOR FOR LINED TRACK ROLLERS USED ON ACTUATION SYSTEM FOR AIRCRAFT LIFT ASSISTING DEVICES

(71) Applicant: Roller Bearing Company of America, Inc., Oxford, CT (US)

(72) Inventor: Frederick S. Gyuricsko, Torrington, CT (US)

(21) Appl. No.: 13/940,305

(22) Filed: Jul. 12, 2013

Related U.S. Application Data
(63) Continuation-in-part of application No. 13/719,541, filed on Dec. 19, 2012.
Application No. 13/719,541 is a continuation-in-part of application No. 13/114,099, filed on May 24, 2011, now Pat. No. 8,387,924.
Application No. 13/114,099 is a division of application No. 12/201,062, filed on Aug. 29, 2008, now Pat. No. 8,025,257.
(60) Provisional application No. 60/992,746, filed on Dec. 6, 2007.

(51) Int. Cl. B64C 13/28; H01R 41/00

(52) U.S. Cl. CPC B64C 13/28; H01R 41/00
USPC 244/99.3; 439/32

(57) ABSTRACT

An electrical conductor for a bearing defines an annular base and is manufactured from an electrically conductive material. The electrical conductor includes a first electrical connector positioned proximate a radially outer peripheral area of the annular base. The electrical conductor includes a second electrical connector positioned proximate a radially inner peripheral area of the annular base. The second electrical connector defines one or more contact edges extending away from the annular base. The contact edge is configured for sliding electrical contact with the bearing.

### CROSS-REFERENCE TO RELATED APPLICATIONS

This patent application is a continuation in part of and claims priority benefit under 35 U.S.C. §120 to U.S. patent application Ser. No. 13/719,541, filed Dec. 19, 2012 which is a continuation in part of and claims priority benefit under 35 U.S.C. §120 to U.S. patent application Ser. No. 13/144,099, filed May 24, 2011, which is a divisional application of and claims priority benefit under 35 U.S.C. §120 to U.S. patent application Ser. No. 12/201,062, filed Aug. 29, 2008, which is a U.S. Utility Application of U.S. Provisional Application Ser. No. 60/992,746, filed Dec. 6, 2007 and to which priority benefit under 35 U.S.C. §119(e) is claimed, and all of which are hereby incorporated by reference in their entirety.

### BACKGROUND OF THE INVENTION

1. Field of the Invention

This invention relates to lined track roller bearing assemblies used within an actuation system of a leading edge of a wing of an aircraft assembly, and more particularly to a shield and electrical conductor for use in the lined track roller bearing assemblies.

2. Description of the Related Art

It is well known to use bearings to reduce friction between moving parts of a mechanical assembly. Similarly, it is well known to use bearings that roll on a fixed track to extend a first component from a second component. One implementation of such a track style bearing is within a wing of an aircraft. For example, fixed wing aircraft typically include slats movably arranged along a leading edge of each wing and flaps movably arranged along a trailing edge of each wing. By selectively extending, retracting, and deflecting the slats and flaps aerodynamic flow conditions on a wing are influenced so as to increase lift generated by the wing during takeoff or decrease lift during landing. For example, during take-off the leading edge slats are moved forward to extend an effective chord length of the wing and improve lift. During flight, the leading edge slats and trailing edge flaps are placed in a retracted position to optimize aerodynamic conditions.

Generally speaking, leading edge slat designs employ a series of roller style bearings that guide fixed tracks to extend the leading edge slats in order to increase lift at slow speed for landing and takeoff. The tracks may have multiple configurations such as, for example, general I-beam and PI-beam shapes. Since the tracks themselves are typically not overly robust in their construction, multiple load conditions may be realized by the track roller bearings. Similarly, side load rollers or pins typically slide against the track to assist in centering the main rollers on the track. The wing also includes actuation systems for positioning the slats and flaps. Actuation systems include, for example, drive motors (e.g., hydraulic or electric drive motors), drive shafts and other bearings such as spherical bearings, bushings and linkage bearings that assist in deployment and retraction of the slats and flaps. As can be appreciated, aircraft wing designs are being continually developed as engineers seek to improve aircraft performance while increasing system capabilities. Newer designs are tending to increase the number of systems employed within a wing cross section. Accordingly, space within the wing cross section is at a premium. Therefore, it is desirable to improve performance characteristics of components (e.g., to reduce maintenance) within the wing while also minimizing space needed for such components.

Based on the foregoing, it is the general object of this invention to provide an improved bearing for use in crucial applications.

### SUMMARY OF THE INVENTION

The present invention resides in one aspect in an actuation system for deploying and retracting a lift assisting device of a wing of an aircraft. The actuation system includes a track pivotally coupled to the lift assisting device, a shaft rotating in response to flight control signals to deploy or retract the lift assisting device, means for actuating the lift assisting device between a retracted position and a deployed position along an arcuate path, a plurality of track roller bearings and a plurality of side roller bearings. The roller bearings rotatably contact the track to guide the track along the arcuate path. In one embodiment, the track roller bearings are comprised of an outer ring, a split inner ring and split liners disposed between bearing surfaces of the outer and the inner rings. The split inner ring is configured for accommodating deflection and bending of a mounting pin coupling the track roller bearing in proximity to the track. In another embodiment, the track roller bearings are comprised of an outer race, an inner race and needle roller elements.

In one embodiment, the means for actuating includes a gear track coupled to the track and a pinion gear coupled to the shaft. The pinion gear has gear teeth that engage the gear track. When the shaft rotates in a first direction the pinion gear engages the gear track to move the lift assisting device from the retracted to the deployed position along the arcuate path. When the shaft rotates in a second direction the pinion gear engages the gear track to move the lift assisting device from the deployed position to the retracted position along the arcuate path. In another embodiment, the means for actuating includes an actuator arm coupled to the track and an actuator lever coupled to the shaft and to the actuator arm. When the shaft rotates in the first direction the actuator lever drives the actuator arm to move the track and the lift assisting device from the retracted to the deployed position along the arcuate path. When the shaft rotates in the second direction the actuator lever drives the actuator arm to move the track and the lift assisting device from the deployed position to the retracted position along the arcuate path.

In still another embodiment, each of the plurality of track roller bearings are comprised of an outer ring having inner bearing surfaces, an inner split ring having a first portion and a second portion, each of the first and second portions having outer bearing surfaces, and a plurality of liners disposed between the inner bearing surfaces of the outer ring and the outer bearing surfaces of the inner ring. Each of the inner rings is comprised of 17-4PH steel and each of the outer rings is comprised of AISI Type 422 stainless steel. In one embodiment, each of the outer rings is comprised of AISI Type 422 stainless steel with a special nitriding hardening process.

In one embodiment, there is provided an actuation system for deploying and retracting a lift assisting device of a leading edge of a wing of an aircraft including a track pivotally coupled to the lift assisting device. The track has first and second outer surfaces and side surfaces. The actuation system includes a shaft rotationally coupled within the wing of the aircraft and operable, in response to flight control signals, to deploy or retract the lift assisting device. The actuation system includes an actuator for actuating the lift assisting device, coupled to the shaft, between a retracted position to a deployed position along an arcuate path. The actuation system includes a plurality of track roller bearings rotatably contacting the first and second outer surfaces of the track to guide the track along the arcuate path. The plurality of track roller bearings includes one or more lined track roller assembly.

In one embodiment, an electrical conductor for a bearing defines an annular base and is manufactured from an electrically conductive material. The electrical conductor includes a first electrical connector positioned proximate a first portion of the annular base. The electrical conductor includes a second electrical connector positioned proximate a second portion of the annular base. The second electrical connector defines one or more contact edges extending away from the annular base. The contact edge is configured for sliding electrical contact with the bearing.

In one embodiment, an actuation system for deploying and retracting a lift assisting device of a leading edged of a wing of an aircraft includes a track pivotally coupled to the lift assisting device. The track has first and second outer surfaces and side surfaces. The actuation system includes a shaft rotationally coupled within the wing of the aircraft and operable, in response to flight control signals, to deploy or retract the lift assisting device. The actuation system includes means for actuating the lift assisting device, coupled to the shaft, between a retracted position to a deployed position along an arcuate path. The actuation system includes a plurality of track roller bearings rotatably contacting the first and second outer surfaces of the track to guide the track along the arcuate path. Each of the track roller bearings has an outer ring and an inner ring positioned at least partially in the outer ring. The plurality of track roller bearings includes one or more one lined track roller assemblies. Each of the lined track roller assemblies has a liner disposed between the outer ring and the inner ring. Each of the lined track roller assemblies has an electrical conductor that defines an annular base. The electrical conductor is manufactured from an electrically conductive material. The electrical conductor has a first electrical connector positioned proximate a first portion of the annular base. The electrical conductor has a second electrical connector positioned proximate a second portion of the annular base. The first electrical conductor is secured to one of the outer ring and the inner ring and is in electrical communication therewith. The second electrical connector extends away from the annular base and defines a contact edge that is in sliding electrical contact with the other of the inner ring and the outer ring.

### BRIEF DESCRIPTION OF THE DRAWINGS

FIG. 1 is a plan view of a wing of an aircraft illustrating a plurality of slat panels located at a leading edge of the wing;

FIG. 2 is a side cross-sectional view of the wing of FIG. 1 taken along line 2-2 illustrating one of the slat panels in a deployed and a retracted position;

FIG. 3 is a front, partial cross-sectional view of a portion of the wing illustrating an actuation system for a slat panel, in accordance with one embodiment of the present invention;

FIG. 4 is a cross-sectional view of a split type lined track roller bearing in accordance with one embodiment of the present invention;

FIG. 5 is a front, partial cross-sectional view of a portion of the wing illustrating side guide roller bearings in accordance with one embodiment of the present invention;

FIG. 6A is a front, partial cross-sectional view of a portion of the wing illustrating an actuation system for a slat panel, having non-split type lined track roller assemblies;

FIG. 6B is an enlarged view of one embodiment of the lined track roller of the present invention;

FIG. 6C is an enlarged view of another embodiment of the lined track roller of the present invention;

FIG. 6D is an enlarged view of another embodiment of the lined track roller of the present invention;

FIG. 7 is a cross-sectional view of a track roller bearing in accordance with one embodiment of the present invention;

FIG. 8 is a plan view of a wing of an aircraft illustrating a plurality of slat panels located at a leading edge of the wing and having lined track roller bearings assemblies;

FIG. 9A is a front, partial cross-sectional view of a portion of the wing illustrating lined side guide roller bearings in accordance with one embodiment of the present invention;

FIG. 9B is a front, partial cross-sectional view of a portion of the wing illustrating lined side guide roller bearings having an electrical conductor secured thereto in accordance with one embodiment of the present invention;

FIG. 10A is a front, partial cross-sectional view of one end of the split or non-split type lined track roller bearings of FIGS. 4 and 6A having a conductive shield thereon;

FIG. 10B is a front, partial cross-sectional view of one end of the split or non-split type lined track roller bearings of FIGS. 4 and 6A having another embodiment of a conductive shield thereon;

FIG. 11 is a top view of the shield of FIG. 10 taken across line 11-11 of FIG. 10A;

FIG. 12A is a front, partial cross-sectional view of one end of the split or non-split type lined track roller bearings of FIGS. 4 and 6A having another embodiment of a conductive shield thereon;

FIG. 12B is a front, partial cross-sectional view of one end of the split or non-split type lined track roller bearings of FIGS. 4 and 6A having another embodiment of a conductive shield thereon;

FIG. 13 is a top view of the shield of FIG. 12 taken across line 13-13 of FIG. 12A;

FIG. 14 is a front, partial cross-sectional view of one end of the split or non-split type lined track roller bearings of FIGS. 4 and 6A having another embodiment of a conductive shield thereon; and

FIG. 15 is another embodiment of a shield for the split or non-split type lined track roller bearings of FIGS. 4 and 6A.

### DETAILED DESCRIPTION OF PREFERRED EMBODIMENTS OF THE INVENTION

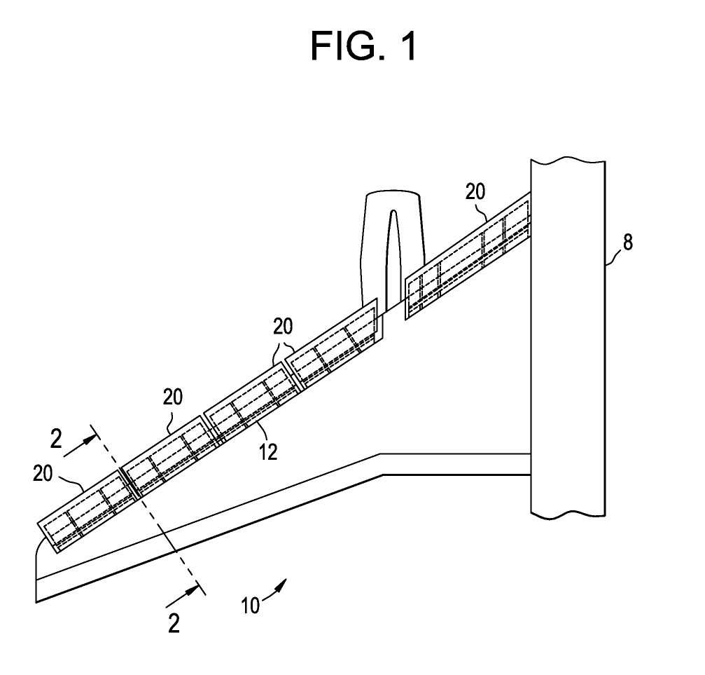

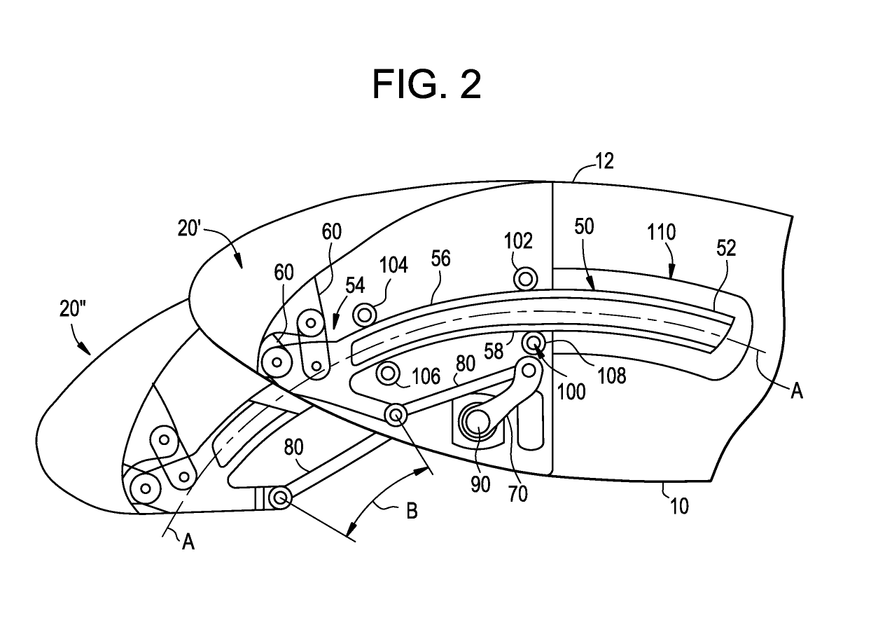

FIG. 1 provides a plan view of a leading edge section 12 of a wing 10 of an aircraft 8. The wing 10 includes a plurality of slat panels 20 deployed along the leading edge 12 of the wing 10. As described herein, an actuation system selectively extends and retracts the slat panels 20 relative to the leading edge 12 in response to flight control signals, as is generally known in the art. FIG. 2 is a partial cross-sectional view of the wing 10 taken along line 2-2 of FIG. 1 and illustrates one of the leading edge slats 20 in a retracted position 20′ and in an extended position 20″. As shown in FIG. 2, in the retracted position (e.g., flight position) the slat 20′ is located against the leading edge 12 of the wing 10 and in the deployed position (e.g., take-off and landing position) the slat 20″ is deployed downwardly and forwardly away from the leading edge portion 12 of the wing 10 thus increasing a surface area of the wing 10 to vary the wing's lift-enhancing characteristics.

An actuation system 40 of each slat 20 includes a track 50 extending along an arcuate axis A from a rear portion 52 to a forward portion 54. It should be appreciated that the track 50 may have multiple configurations such as, for example, an I-beam shape and a PI-beam shape. Generally speaking, webbing that constitutes support elements of the track is not overly robust. As such, multiple load conditions are experienced at the track during operation that may be carried and distributed by roller style bearings, as are described herein, to, for example, the wing structure of the aircraft.

As shown in FIG. 2, the forward portion 54 of the track 50 is pivotally coupled to an interior surface of the slat 20. In one embodiment, the track 50 is coupled to the slat 20 by means of, for example, linkage bearings 60. The actuation system 40 also includes an actuator lever 70. The actuator lever 70 is coupled to the track 50 via an actuator arm 80. The actuator lever 70 is also coupled to a shaft 90. As is generally known in the art, the shaft 90 extends along the leading edge section 12 of the wing 10 and operates a plurality of actuator levers (similar to lever 70) coupled to respective ones of the plurality of slat panels 20 in response to flight control commands to extend the slats when rotating in a first direction and to retract the slats 20 when rotating in a second direction.

A plurality of track roller bearings 100 are disposed about a first outer surface 56 and a second outer surface 58 of the track 50. The track roller bearings 100 are in rotational contact with the outer surfaces 56 and 58 of the track 50 to guide the track 50 in its arcuate path along axis A during deployment and retraction. The path of travel of the slat 20 is illustrated in FIG. 2 by arrow B. As shown in FIG. 2, the plurality of track roller bearings 100 includes a first pair of track roller bearings 102 and 104 and a second pair of track roller bearings 106 and 108. It should be appreciated that it is within the scope of the present invention to include more or less than the illustrated two pairs of roller bearings. For example, three roller bearings may be disposed about one or both of the first outer surface 56 and/or second outer surface 58 of the track 50. As described in detail below, it is also within the scope of the present invention for the plurality of track roller bearings 100 to include rolling element needle style track rollers or self lubricating style track rollers. In one embodiment, a mounting web 110 encloses at least a portion of the track 50. In one embodiment, the mounting web 110 extends into a fuel tank disposed within the wing of the aircraft.

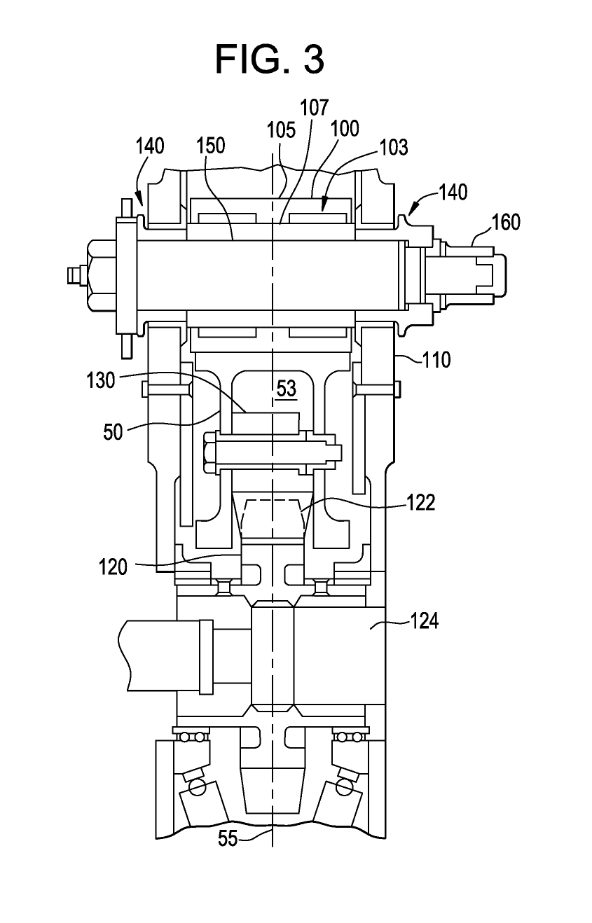

In one embodiment illustrated in FIG. 3, the actuation system 40 includes a pinion gear 120 having teeth 122 that drive a gear track 130 disposed within an interior portion 53 of the track 50. Preferably, the gear track 130 is positioned on a vertical centerline 55 of the track 50. The pinion gear 120 is coupled to a shaft 124 (such as the shaft 90) that rotates in response to flight control commands. As the shaft 124 and the pinion gear 120 rotate, a drive force is provided to the gear track 130 for driving the track 50 along axis A between one of the retracted position 20′ and the extended position 20″ (FIG. 2). As shown in FIG. 3, the track roller bearing 100 is coupled to the mounting web 110 about the track 50. For example, as shown in FIG. 3, the track roller bearing 100 is coupled to the mounting web 110 above the track 50.

As shown in FIG. 2, the plurality of track roller bearings 100 are coupled to the mounting web 110 about the first and second outer surfaces 56 and 58 of the track 50 to support and guide the track 50 during deployment and retraction. In one embodiment, illustrated in FIG. 3, the track roller 100 is coupled to the mounting web 110 using opposing bushings 140, a mounting pin 150 and a nut 160. In one embodiment, the opposing bushings 140 are comprised of eccentric bushings and the nut 160 is comprised of a castellated nut to allow adjustment to the track 50 at fit-up. As shown in FIG. 3, the track roller bearing 100 includes a plurality of needle roller elements 103 (e.g., two rows of needle rollers in a double channel design). The needle roller elements 103 are lubricated with grease such as, for example, Aeroshell 33, Mobil 28, Aerospec 200 or Aeroplex 444 as is required by predetermined maintenance procedures. In one embodiment, an outer ring 105, an inner ring and 107 and needle rollers 103 of the track roller bearings 100 are comprised of hardened stainless steel such as, for example, 440C, 52100, 422 stainless with a special nitriding process (AeroCres®) (AEROCRES is registered trademark of RBC Aircraft Products, Inc., Oxford, Conn. USA), XD-15NW, and Cronidur 30.

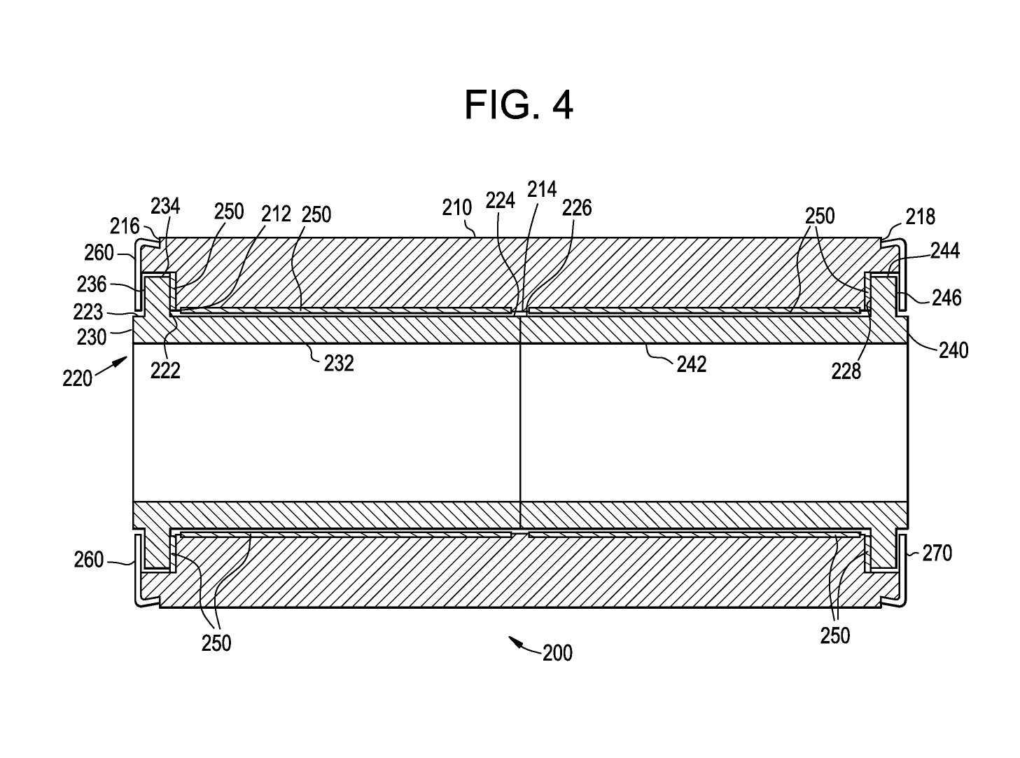

In another embodiment, illustrated in FIG. 4, the track roller bearing 100 is comprised of a lined split type track roller assembly 200 including an outer ring 210 and an inner ring 220. The inner ring 220 is a split ring including a first portion 230 and a second portion 240. In one embodiment, the first portion 230 and the second portion 240 include respective body portions 232 and 242 as well as head portions 234 and 244. The head portions 234 and 244 include flanges 236 and 246, respectively. In accordance with the present invention, the split ring configuration of the first portion 230 and the second portion 240 due to their ability to deflect relative to one another, accommodate potential deflection and/or bending of the mounting pin 150 from stresses that may be encountered during, for example, aircraft takeoff and landing. As can be appreciated, unless accounted for a bending of the mounting pin 150 may result in high friction or binding of the track roller 100 or 200 and a failure to deploy or retract slats in response to flight control commands. The flanges 236 and 246 control axial motion of the outer ring 210 to substantially eliminate contact of the outer ring 210 and the opposing bushings 140 utilized to mount the track roller 100 and 200 within the mounting web 110.

As shown in FIG. 4, the lined track roller assembly 200 may also include liners 250 disposed between bearing surfaces 212, 214 of the outer ring 210 and bearing surfaces 222, 224, 226 and 228 of the inner ring 220. In one embodiment, the liners 250 are constructed of polytetrafluoroethylene (commercially available under the designation TEFLON®) (TEFLON is a registered trademark of E.I. DuPont De Nemours and Company, Wilmington, Del. USA), polyester, graphite, fabric impregnated with a polymer, urethane, polyimide, epoxy, phenolic or other type of resin. In one embodiment, the liners 250 are molded and are comprised of polytetrafluoroethylene (TEFLON®), polyester, graphite, fibers in a thermosetting composite resin made from polyester, urethane, polyimide, epoxy, phenolic or other type of resin. In one embodiment, the outer ring 210 and the inner ring 220 is comprised of hardened stainless steel such as, for example, 440C, 52100, Custom 455®, Custom 465® (CUSTOM 455 and CUSTOM 465 are registered trademarks of CRS Holdings, Inc., Wilmington, Del., USA), and corrosion resistance steel such as 17-4PH, 15-5PH and PH13-8Mo.

In one embodiment, the lined track roller assembly 200 also includes shields 260 and 270 disposed about shoulder portions 216 and 218 of an outer diameter of the outer ring 210 and extending to an outer diameter 223 of the inner ring 220. As shown in FIG. 4 the shield 260 is spaced apart from the flange 236 and the shield 270 is spaced apart from the flange 246 by a small distance, the magnitude of which is suitable to prevent debris from entering therebetween. The inventors have discovered that the shields 260 and 270 reduce friction and discourage dust and other contaminates from entering and compromising contact between the bearing surfaces 212, 214 of the outer ring 210 and bearing surfaces 222, 224, 226 and 228 of the inner ring 220.

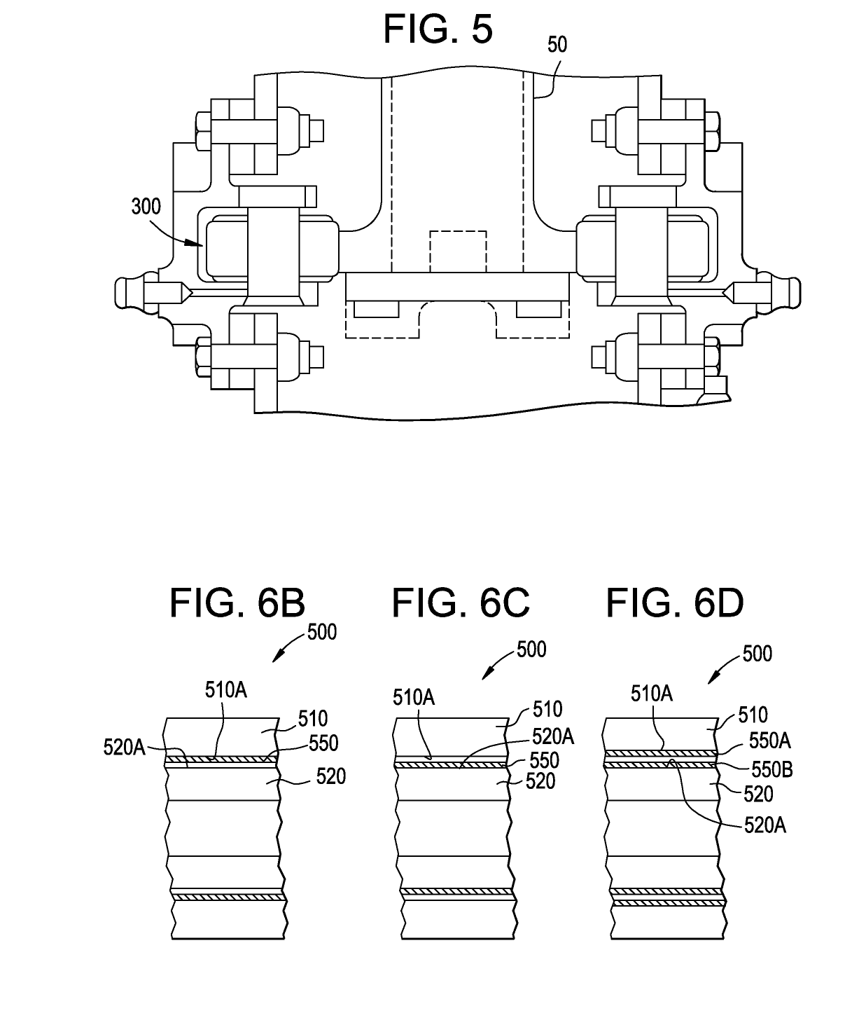

In one embodiment, illustrated in FIG. 5, a plurality of side guide roller bearings 300 are disposed about opposing sides of the track 50. The side guide roller bearings 300 are in rotational contact with the opposing side surfaces of the track 50 to guide the track 50, along with track roller bearings 100 and 200, in its arcuate path along axis A during deployment and retraction. In one embodiment, the plurality of side guide roller bearings 300 are in rotational contact with wear pads affixed to the track 50. In one embodiment, the plurality of side guide roller bearings 300 include needle roller bearings having outer races, inner races and needle rollers constructed of hardened stainless steel such as, for example, 440C, 52100, 422 stainless with a special nitriding process (e.g., the aforementioned AeroCres® process), XD-15NW, and Cronidur 30. In yet another embodiment, the side guide roller bearings 300 include end washers and seals. The end washers are constructed of, for example, 52100 steel with cadmium plate or 420 stainless steel. The seals are made from a thermoplastic such as, for example, an acetal copolymer with lubricant fillers or Delrin®/Celcon® (DELRIN is a registered trademark of E.I. DuPont De Nemours and Company, Wilmington, Del. USA, and CELRON is a registered trademark of CNA Holdings, Inc., Summit, N.J. USA). The seals retain grease and prevent of ingress dirt, dust and other contaminates into the bearings 300. In one embodiment, needle roller elements of the bearings 300 are lubricated with grease such as, for example, Aeroshell 33, Mobil 28, Aerospec 200 or Aeroplex 444 as is required by predetermined maintenance procedures.

As described above, both the rolling element track bearings 100 and self lubricating track roller bearings 200 include a hard outer ring or race to work in harmony with the mating track 50 that the bearings roll against. In one embodiment, the track 50 is comprised of titanium or steel. In one embodiment, the track 50 may be coated with a material such as, for example, tungsten carbide, although a coating is not a requirement of the present invention.

In addition to a unique bearing mounting configuration, another aspect of the present invention is related to the materials from which the bearings are manufactured. Historically, lined track bearings are manufactured from relatively soft materials. For example, inner rings are typically comprised of precipitation-hardening martensitic stainless steel such as, for example, 17-4PH steel, having a Rockwell hardness in a range of about HRc 30s to about HRc 40s, while outer rings are typically comprised of precipitation-hardening stainless steel such as, for example, custom 455 steel, having a Rockwell hardness in the range of about HRc 40s. Outer rings may also be manufactured as through hardened high strength steel having a Rockwell hardness of in the range of about HRc 50s to avoid flats that can occur. 440C steel has also been used for outer rings. The inventors have discovered that, in certain applications, it is beneficial to maintain inner rings manufactured from 17-4PH steel, and that it is desirable to manufacture outer rings of AISI Type 422 stainless steel. In one embodiment, each of the outer rings is comprised of AISI Type 422 stainless steel with a special nitriding hardening process (e.g., the aforementioned AeroCres® process). Outer rings comprised of AISI Type 422 stainless steel with AeroCres® hardening are preferred for superior corrosion resistance and performance as compared to conventional outer rings manufactured of 440C steel.

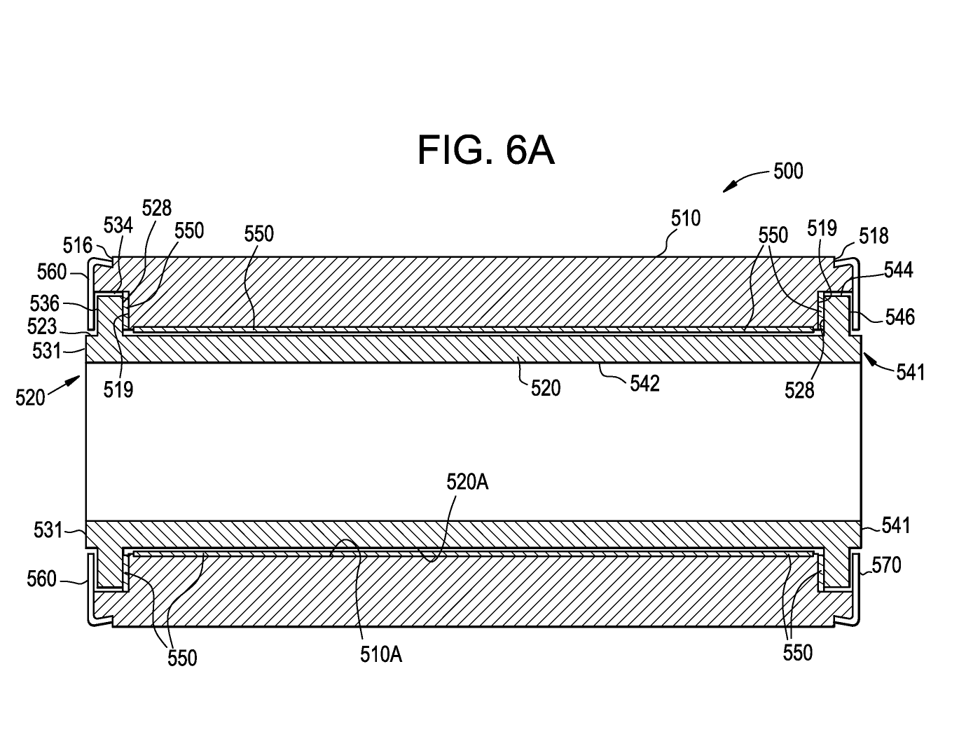

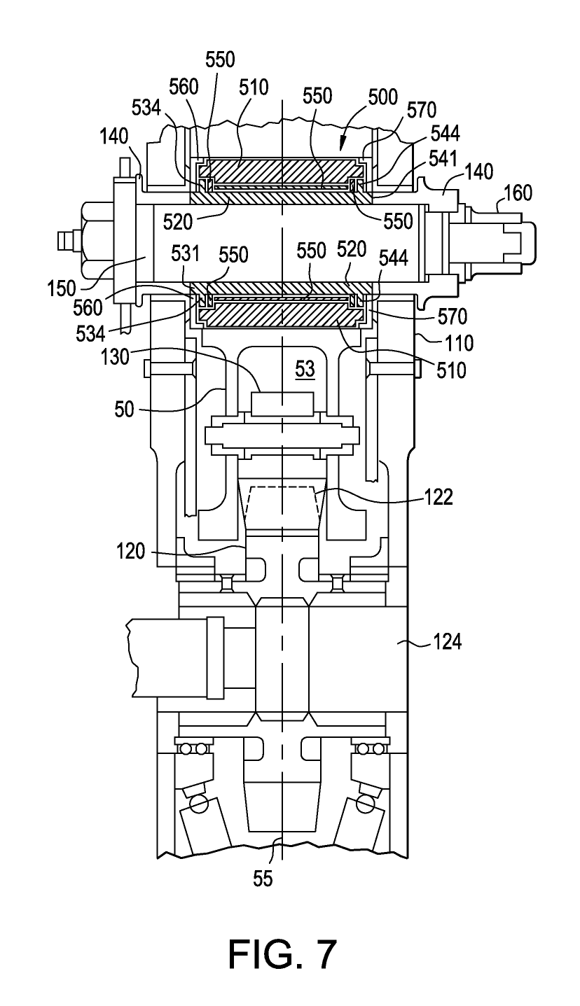

In another embodiment, illustrated in FIG. 6A, the non-split type lined track roller bearing 500 is similar to the track roller bearing of FIG. 4, thus like elements have been assigned similar element numbers with the first numeral 2 being replaced with the numeral 5. The lined track roller bearing 500 is a non-split type lined track roller assembly 500 including an outer ring 510 and an inner ring 520. The inner ring 520 is disposed at least partially in the outer ring 510. The outer ring 510 defines an inner bearing surface 510A and the inner ring 520 defines an outer bearing surface 520A. The inner ring 520 extends continuously from a first end 531 to a second end 541. Thus the lined track roller bearing 500 has no split and no separate first portion 230 and second portion 240, as shown in FIG. 4. The inner ring 520 defines a continuous body portion 542 as well as head portions 534 and 544 proximate the first end 531 and the second end 541, respectively. The head portions 534 and 544 include flanges 536 and 546, respectively. The flanges 536 and 546 control axial motion of the outer ring 510 to substantially eliminate contact of the outer ring 510 with the opposing bushings 540 utilized to mount the track roller 500 within the mounting web 310, illustrated in FIG. 7. While the lined track rollers 500 are shown and described as having no split and no separate first portion 230 and second portion 240, the present invention is not limited in this regard, as the lined track rollers 500 having a split configuration as shown in FIG. 4 may also be employed without departing from the broader aspects defined herein.

As shown in FIGS. 6A and 6B, the non-split type lined track roller assembly 500 includes liners 550 disposed between the outer ring 510 the inner ring 520. As shown in FIGS. 6A and 6B, the liner 550 is disposed on, for example, secured to (e.g., by an adhesive or by bonding) the inner bearing surface 510A of the outer ring 510 and the liner 550 slidingly engages the outer bearing surface 520 of the inner ring 520. A liner 550 is also disposed between an inside facing lateral surface 528 of the each of the head portions 534 and 544 and an outwardly facing lateral surface 519 of the outer ring 510. The lined track roller assembly 500 also includes shields 560 and 570 disposed about shoulder portions 516 and 518 of an outer diameter of the outer ring 510 and extending to an outer diameter 523 of the inner ring 520. As shown in FIG. 6A the shield 560 is spaced apart from the flange 536 and the shield 570 is spaced apart from the flange 546 by a small distance, the magnitude of which is suitable to prevent debris from entering therebetween. The liners 550 are manufactured from materials similar or identical to those described above for the liners 250. While the liner 550 is shown in FIGS. 6A and 6B and described as being disposed on the inner bearing surface 510A, the present invention is not limited in this regard as the liner 550 may be disposed on the outer bearing surface 520A of the inner ring 520 and the liner 550 slidingly engages the inner bearing surface 510A of the outer ring 510, as shown in FIG. 6C. In another embodiment, as shown in FIG. 6D, a liner 550A, similar to the liner 550, is disposed the inner bearing surface 510A of the outer ring 510 and a liner 550B, similar to the liner 550, is disposed in the outer bearing surface 520A of the inner ring 520, as shown in FIG. 6D, wherein the liners 550A and 550B slidingly engage one another.

The mounting web 510 of FIG. 7 is similar to the mounting web of FIG. 3; therefore like elements for the track roller bearing 500 have been assigned similar element numbers with the first numeral 2 being replaced with the numeral 5. As shown in FIG. 7, the track roller bearing 500 is coupled to the mounting web 110 above the track 50. With reference to FIG. 1, one or more of the track roller bearings 102, 104, 106 and 106 are lined track rollers 500 as illustrated in FIG. 5. The non-split type lined track roller 500 is coupled to the mounting web 110 using opposing bushings 140, a mounting pin 150 and a nut 160.

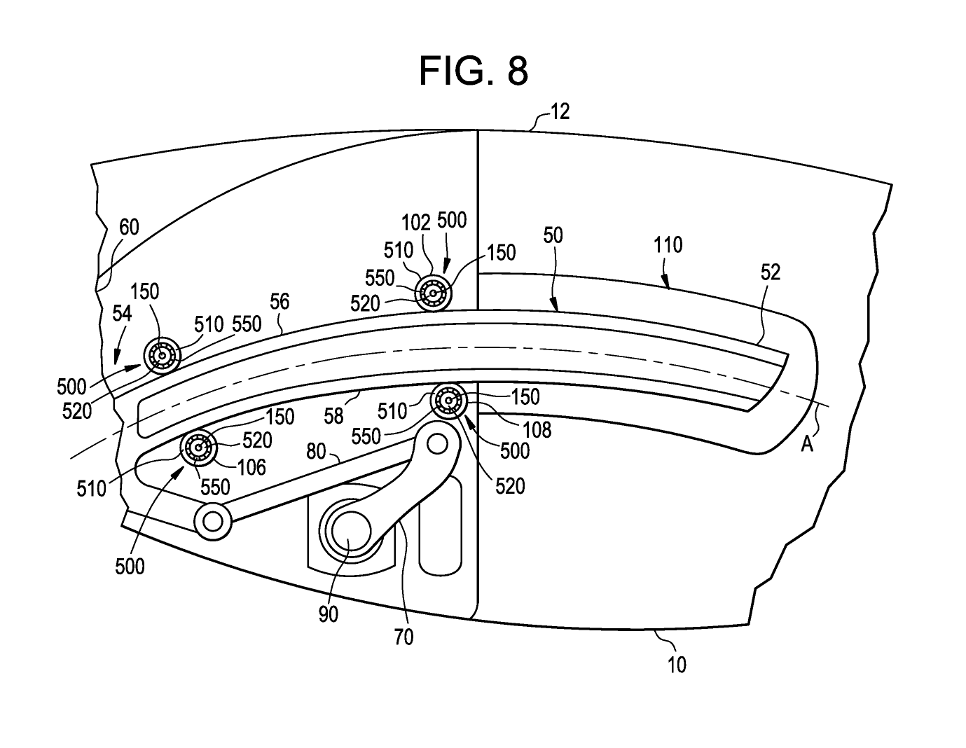

Referring to FIG. 8, in one embodiment, all of the track roller bearings 102, 104, 106 and 108 are lined track rollers 500 similar to those as illustrated in detail in FIGS. 6A, 6B, 6C and/or 6D.

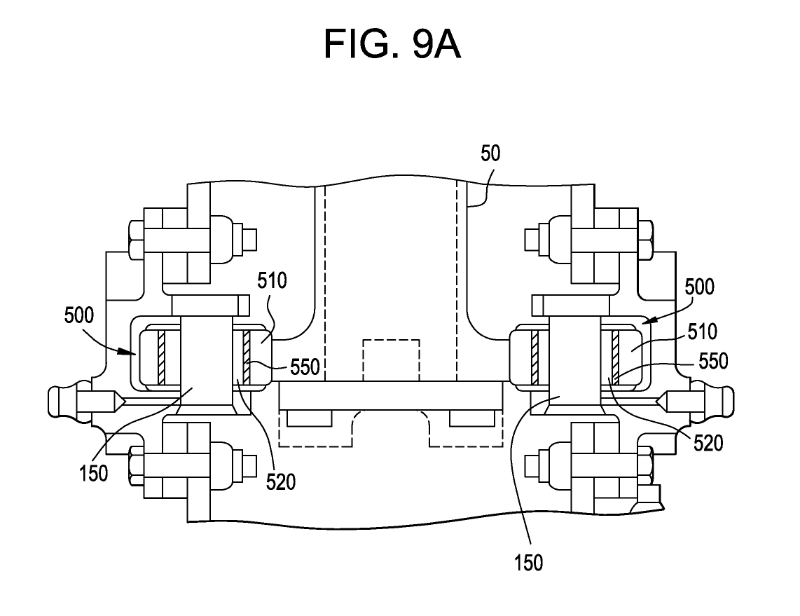

Referring to FIG. 9A, the plurality of side guide roller bearings 500 are disposed about opposing sides of the track 50 in a manner similar to that described above with reference to the side guide track roller 300 of FIG. 5. However, one or more of the side guide roller bearings 500 are lined roller bearings similar to the lined track roller bearings 500 shown in FIGS. 6A, 6B, 6C, and/or 6D. In one embodiment, all of the side guide roller bearings 500 are lined roller bearings similar to the lined track roller bearings 500.

Surprisingly, use of the lined track rollers 500 in the actuation system of leading edge flaps on an aircraft has benefit over bearings having needle rollers. Actuation systems are limited as to how much force they can apply. Since lined track rollers have a higher friction coefficient than needle roller track rollers, one skilled in the art of bearing design for aircraft applications would be discouraged from using a system that includes lined track rollers as it will take more force to actuate the system. However, one surprising benefit of lined track rollers is to move away from track rollers that require grease. By moving away from rollers that require grease, heavy hydraulic greasing systems do not have to be included on the aircraft and this benefit of reduced weight and complexity has been discovered overcome the determinant of higher friction compared to the lower friction needle rollers.

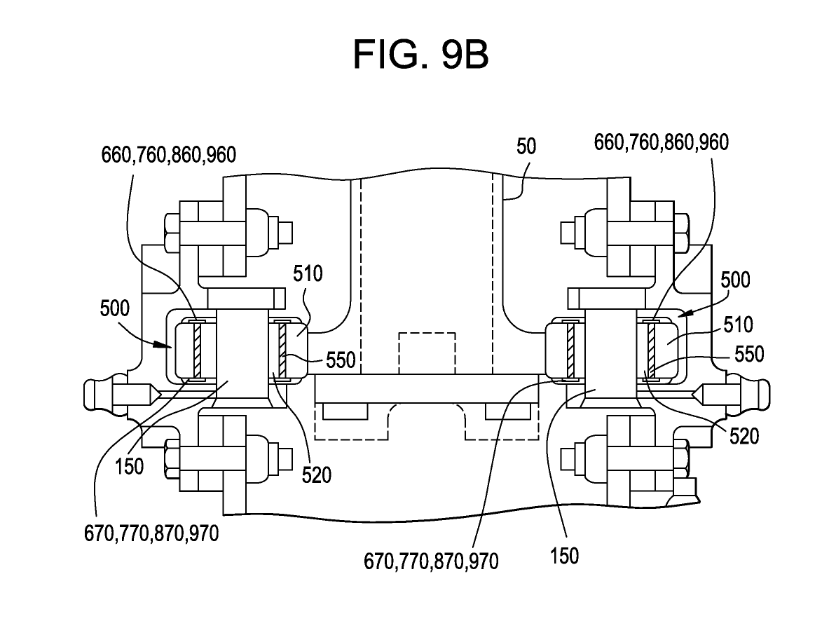

Referring to FIG. 10A, the split ring lined track roller bearing 200 of FIG. 4 and the non-split ring lined track roller bearing 500 of FIG. 6A each have a shield 660 positioned proximate the shoulder portions 216, 516 and a shield 670 positioned proximate the shoulder portions 218, 518, similar to that described herein with reference to FIGS. 4 and 6A for the shields 260, 270, 560 and 570. The shields 660 and 670 are similar to one another. However, FIG. 10A shows the shields 660 and 670 positioned on the shoulder portions 216, 516 for simplicity of illustration, rather than showing the shields positioned on the shoulder portions 218 and 518. The split ring lined track roller bearing 200 of FIG. 4 includes a liner 250 positioned between the outer ring 210 and the inner ring 220; and the non-split ring lined track roller bearing 500 includes a liner 550 positioned between the outer ring 510 and the inner ring 520. The liners 250 and 550 are manufactured from a dielectric material that is an electrical insulator (e.g., PTFE), thereby precluding electrical communication between the respective outer ring 210, 510 and the respective inner ring 220, 520, via the respective liner 250, 550.

Referring to FIG. 10A, the shields 660, 670 are electrical conductors manufactured from an electrically conductive material, such as a metal. The shields 660, 670 are generally annular and have a base portion 693 that extends radially outward from an inner circumferential edge 696. The inner circumferential edge 696 defines a generally circular opening 697 in each of the shields 660, 670. The inner circumferential edge 696 extends a thickness T6 to a contact edge 695 of the respective shield 660, 670. The contact edge 695 is an electrical connector that is positioned proximate a first portion 693A (e.g., proximate the inner circumferential edge 696) of the annular base 693. The contact edge 695 is angled axially inward toward the flange 236, 536 via a bend 694. The contact edge 695 slidingly engages an axially outward facing surface of the flange 236, 536. A radially outer portion 691 of the respective shield 660, 670 defines another electrical connector positioned proximate a second portion of the annular base 693. For example, the radially outer portion 691 is secured to and is in electrical communication with the shoulder portion 216, 516. The radially outer portion 691 is angled axially inward toward the shoulder portion 216, 516 at a second bend 692 so that an annular edge 690 of the respective shield 660, 670 engages the respective shoulder portion 216, 516. In one embodiment, the annular edge 690, portions of an underside 691A of the radially outer portion 691 and/or portions of an underside 693B of the base portion 693 constitute an electrical connector for providing electrical communication with the outer ring 210, 510.

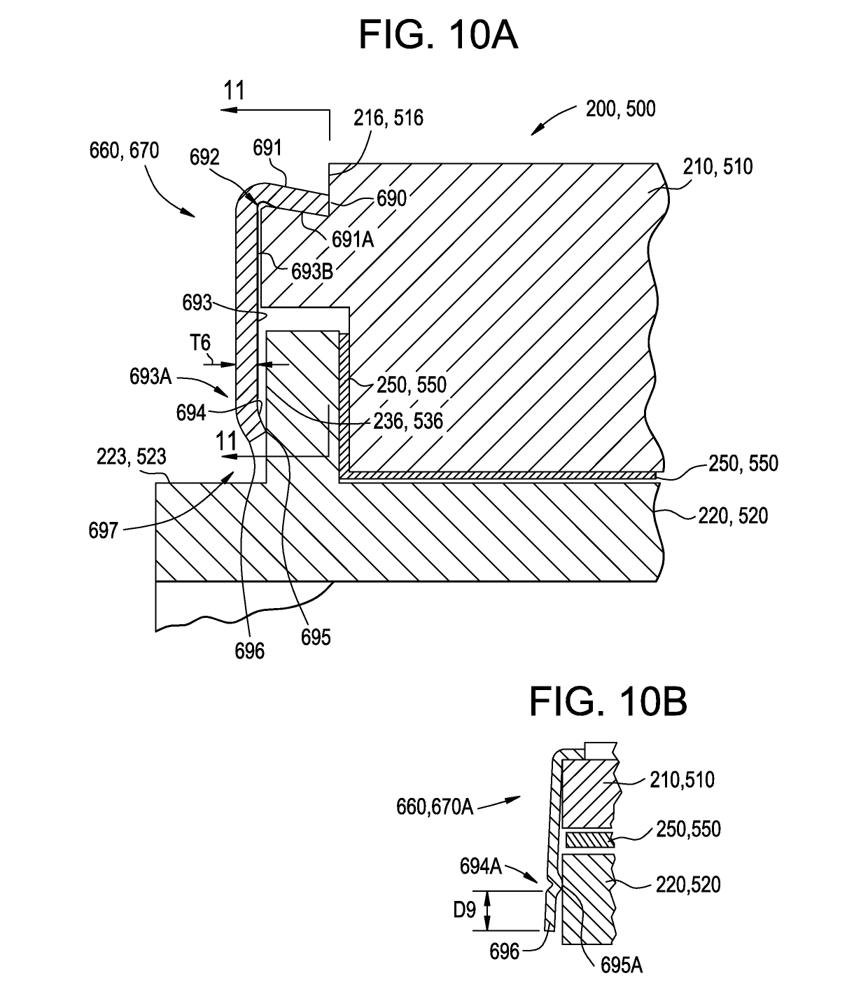

As shown in FIG. 11, the contact edge 695 and bend 694 are continuously and entirely formed around 360 degrees of the circumference of the inner diameter D6 of the respective shield 660, 670. The shields 660, 670 provide electrical communication between the outer ring 210, 510 and the inner ring 220, 520 via the engagement between the annular edge 690 and the respective shoulder portion 216, 516; through the conductive shield 660, 670; and via the sliding engagement between the contact edge 695 and the axially outward facing surface of the flange 236, 536.

While the annular edge 690, portions of an underside 691A of the radially outer portion 691 and/or portions of an underside 693B of the base portion 693 are shown and described as providing electrical communication with the outer ring 210, 510; and the contact edge 695 is shown and described as being the electrical connector that is positioned proximate the first portion 693A (e.g., proximate the inner circumferential edge 696 as shown in FIG. 10A), the present invention is not limited in this regard as electrical communication between portions of the shield 660, 670 may occur at any location on the shields 660A, 670A (see FIG. 10B) including but not limited to a position at a bend 694B that creates a bulged contact edge 695A in the shield at a distance D9 from the inner circumferential edge 696, as shown in FIG. 10B.

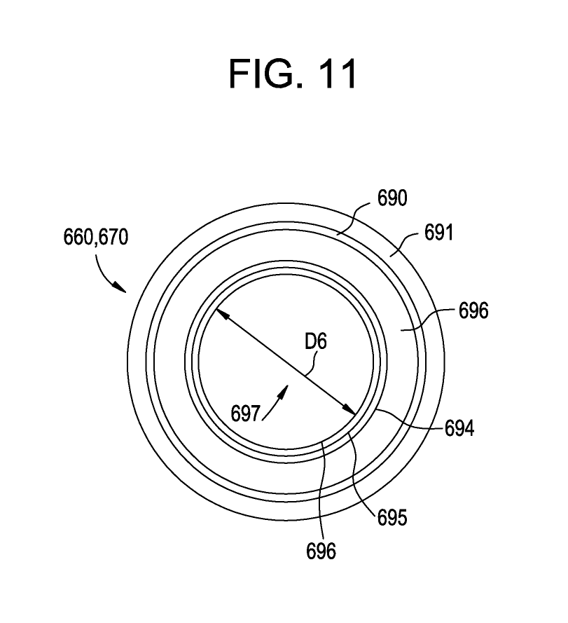

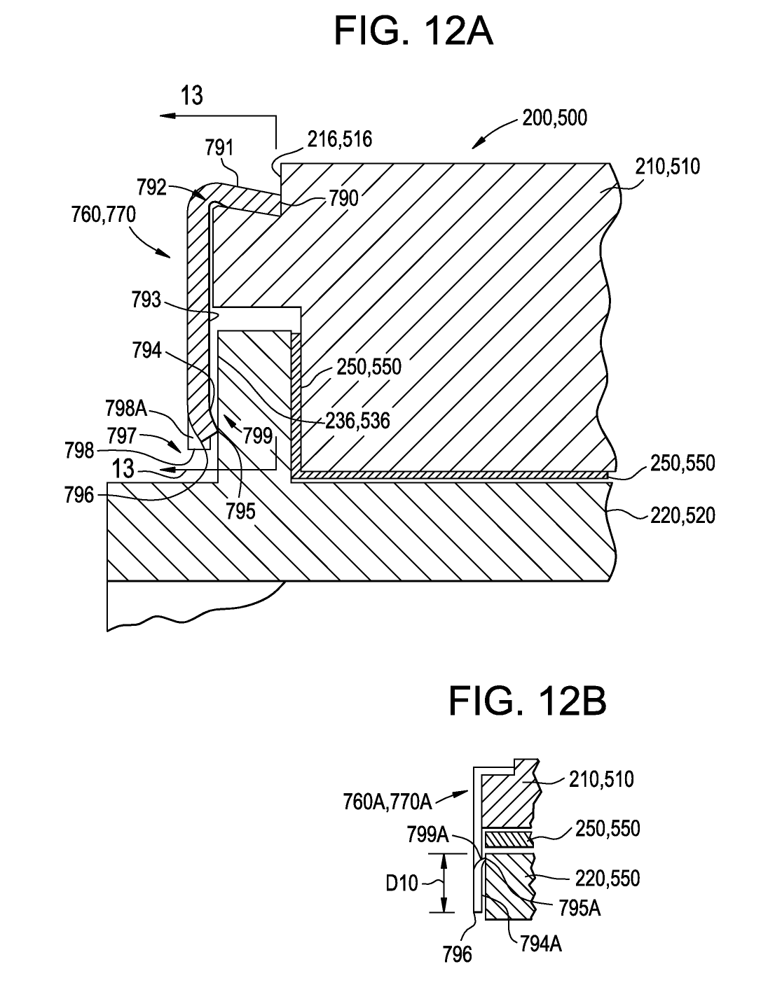

Referring to FIGS. 12A and 13, the shields 760, 770 are similar to the shields 660, 670 of FIGS. 10A, 10B and 11, with the exception that the contact edge 695 and bend 694 are not continuously formed around 360 degrees of the circumference of the inner diameter D6 of the respective shield 760, 770. Instead, the shields 760, 770 have four tabs 799 that are angled axially inward toward the respective flange 236, 536 at a bend 794 such that a contact edge 795 of each of the tabs 799 slidingly engages the axially outer facing surface of the flange 236, 536. The tabs 799 are shown symmetrically spaced at 90 degree increments around an inner circumference defined by an inner diameter D7. Each of the tabs 799 has a base defined at the bend 794 and sides that are separated from (e.g., via two radial extending cuts) a peripheral portion of the shield 760, 770 adjacent to the inner diameter D7. Each of the tabs 799 extends a width W7 between opposing faces 798A and 798B of the peripheral portion of the shield 760, 770. The shields 760, 770 provide electrical communication between the outer ring 210, 510 and the inner ring 220, 520 via the engagement between the annular edge 790 and the respective shoulder portion 216, 516; through the conductive shield 760, 770 and via the sliding engagement between the contact edge 795 and the axially outward facing surface of the flange 236, 536.

While the shields 760, 770 are shown and described as having four tabs 799 symmetrically spaced thereon, the present invention is not limited in this regard as any number of tabs positioned in any configuration may be employed. While the tabs 799 are shown and described as being angled axially inward toward the respective flange 236, 536 at the bend 794 such that the contact edge 795 of each of the tabs 799 slidingly engages the axially outer facing surface of the flange 236, 536 at 90 degree increments around an inner circumference defined by an inner diameter D7, the present invention is not limited in this regard as other contact edge configurations may be employed including but not limited to pins or brushes extending from the shield onto the inner ring 220, 520 or tabs 799A may be pierced through the shield at any position such that a contact edge 795A is positioned at any location such as but not limited to a distance D10 from the inner circumferential edge 796, as shown in FIG. 12B.

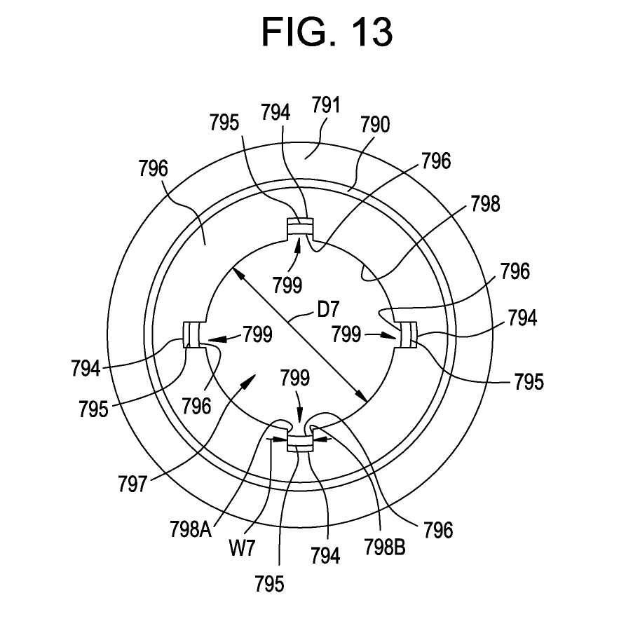

As shown in FIG. 14, the shields 860, 870 are similar to the shields 660, 670 of FIGS. 10A, 10B and 11 or the shields 760, 770 of FIGS. 12A, 12B and 13, with the exception that the shields 860, 870 include a flexible annular seal 801 (e.g., polymer based material, PTFE (Polytetrafluoroethylene), acrylic resin based material, nylon, rubber, Teflon, or the like) positioned on (e.g., adhered to or mechanically secured to) an axially outward facing surface of the shield 860, 870. The seal 801 defines a radially inner peripheral surface 802 that slidingly engages the outer diameter 223, 523 of the inner ring 220, 520 to provide a further barrier preventing debris from reaching the liner 250, 550.

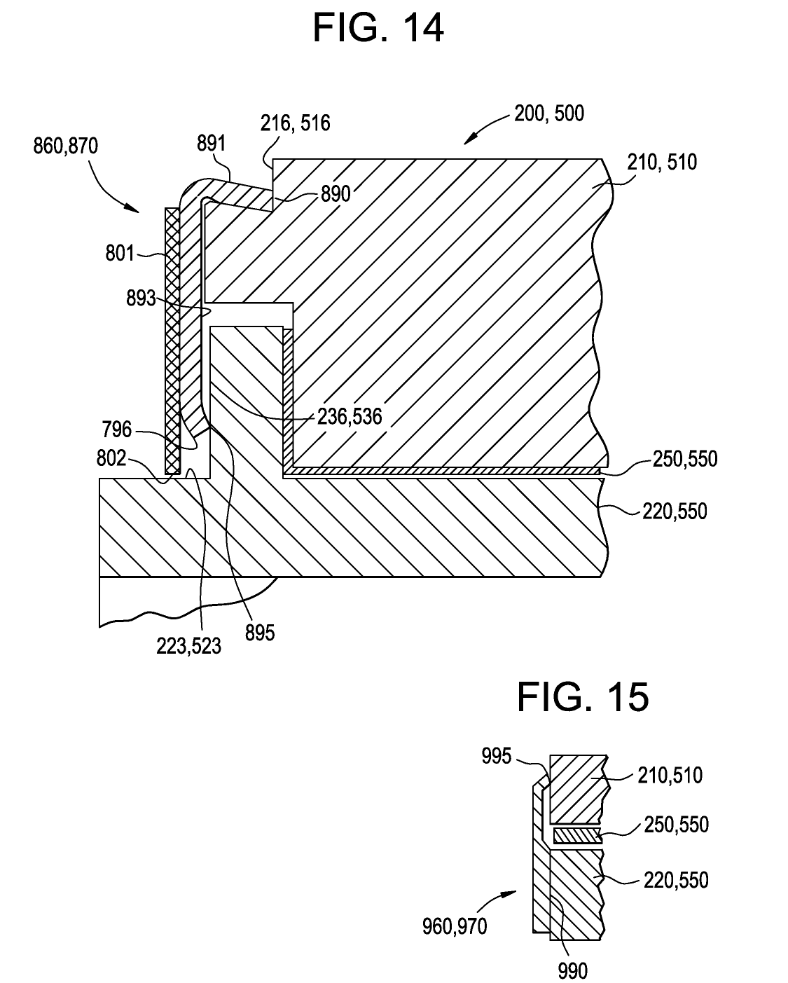

While the shields 660, 670, 760, 770, 860, and 870 are shown and described as having the annular edge 690 of the respective shields 660, 670, 760, 770, 860, and 870 engaged and secured to the respective shoulder portion 216, 516 of the outer ring 210, 510 and the contact edge 695, 795, 895 being in sliding electrical contact with the inner ring 220, 520, the present invention is not limited in this regard as a portion 990 of the shields 960, 970 may be secured to a portion of the inner ring 220, 520 and another portion of the shields 660, 670, 760, 770, 860, and 870 may have a contact edge 995 that is in sliding electrical contact with a portion of the outer ring 210, 510 as shown, for example, in FIG. 15 for the shield 960, 970.

Referring to FIG. 9B, the side rollers 500 are lined roller bearing assemblies having a liner 550 disposed between the inner ring 520 and the outer ring 510. One of the shields 660, 670, 760, 770, 860, 870, 960 or 970 are positioned on one or more or all of the side rollers 500, in a manner and configuration similar to that described herein with reference to FIGS. 10A, 10B, 11, 12A, 12B, 13, 14 and 15.

Although the invention has been described with reference to particular embodiments thereof, it will be understood by one of ordinary skill in the art, upon a reading and understanding of the foregoing disclosure that numerous variations and alterations to the disclosed embodiments will fall within the spirit and scope of this invention and of the appended claims.

What is claimed is:

1. An electrical conductor for a bearing, the electrical conductor comprising:
an annular base manufactured from an electrically conductive material;
a first electrical connector positioned proximate a first portion of the annular base; and
a second electrical connector positioned proximate a second portion of the annular base, the second electrical connector defines at least one contact edge extending away from the annular base, the contact edge being configured for sliding electrical contact with the bearing.

2. The electrical conductor of claim 1, wherein the at least one contact edge extends continuously and entirely around the radially inner peripheral area of the annular base.

3. The electrical conductor of claim 1, wherein the at least one contact edge comprises a plurality of tabs spaced apart from one another.

4. The electrical conductor of claim 1, further comprising a flexible seal positioned on the annular base, the flexible seal having an end configured for sliding contact with the bearing.

5. An actuation system for deploying and retracting a lift assisting device of a leading edged of a wing of an aircraft, the actuation system comprising:
a track pivotally coupled to the lift assisting device, the track having first and second outer surfaces and side surfaces;
a shaft rotationally coupled within the wing of the aircraft and operable, in response to flight control signals, to deploy or retract the lift assisting device;
means for actuating the lift assisting device, coupled to the shaft, between a retracted position to a deployed position along an arcuate path;
a plurality of track roller bearings rotatably contacting the first and second outer surfaces of the track to guide the track along the arcuate path, each of the track roller bearings having an outer ring and an inner ring positioned at least partially in the outer ring;
the plurality of track roller bearings including at least one lined track roller assembly, each of the lined track roller assemblies having a liner disposed between the outer ring and the inner ring; and
an electrical conductor defining an annular base and being manufactured from an electrically conductive material, the electrical conductor having a first electrical connector positioned proximate a first portion of the annular base, electrical conductor having a second electrical connector positioned proximate a second portion of the annular base;
the first electrical conductor being secured to one of the outer ring and the inner ring and being in electrical communication therewith; and
the second electrical connector extending away from the annular base and defining a contact edge that is in sliding electrical contact with the other of the inner ring and the outer ring.

6. The actuation system of claim 5, wherein the plurality of track roller bearings includes at least one track roller assembly in rotational contact with an upper surface of the track and at least one track roller assembly in rotational contact with a lower surface of the track.

7. The actuation system of claim 5, wherein the all of the plurality of track roller bearings are the lined track roller assembly.

8. The actuation system of claim 5, wherein the means for actuating is comprised of:
an actuator arm coupled to the track; and
an actuator lever coupled to the shaft and to the actuator arm;
wherein when the shaft rotates in a first direction the actuator lever drives the actuator arm to move the track and the lift assisting device from the retracted to the deployed position along the arcuate path, and when the shaft rotates in a second direction the actuator lever drives the actuator arm to move the track and the lift assisting device from the deployed position to the retracted position along the arcuate path.

9. The actuation system of claim 5, wherein the actuation system further includes a mounting web enclosing at least a portion of the track and wherein the plurality of track roller bearings are coupled to the mounting web.

10. The actuation system of claim 9, wherein the track roller bearings are coupled to the mounting web with opposing bushings, a mounting pin and a nut.

11. The actuation system of claim 10, wherein the opposing bushings are comprised of eccentric bushings and the nut is comprised of a castellated nut to allow adjustment to the track at fit-up.

12. The actuation system of claim 5 comprising a plurality of side roller bearings rotatably contacting at least one side of the track to guide the track along the arcuate path.

13. The actuation system of claim 12 wherein at least one of the side roller bearings is a lined track roller assembly.

14. The actuation system of claim 5, wherein the at least one contact edge extends continuously and entirely around the radially inner peripheral area of the annular base.

15. The actuation system of claim 5, wherein the at least one contact edge comprises a plurality of tabs spaced apart from one another.

16. The actuation system of claim 5, further comprising a flexible seal positioned on the annular base, the flexible seal having an end configured for sliding contact with the bearing.

17. The actuation system of claim 5, wherein the inner ring is a split ring comprising a first portion and a second portion.
